(19) United States
(12) Patent Application Publication
(10) Pub. No.: US 2012/0245915 A1
(43) Pub. Date: Sep. 27, 2012

(54) SEMICONDUCTOR INTEGRATED CIRCUIT SIMULATION APPARATUS AND SIMULATION METHOD FOR SEMICONDUCTOR INTEGRATED CIRCUIT

(75) Inventor: Atsushi KAGESHIMA, Kanagawa (JP)

(73) Assignee: KABUSHIKI KAISHA TOSHIBA, Tokyo (JP)

(21) Appl. No.: 13/235,122

(22) Filed: Sep. 16, 2011

(30) Foreign Application Priority Data
Mar. 23, 2011 (JP) 2011-064630

(51) Int. Cl. G06F 17/50

(52) U.S. Cl. 703/14

(57) ABSTRACT

According to an embodiment, a simulation apparatus has a bus architecture information acquiring module configured to acquire bus architecture information of a bus included in a semiconductor integrated circuit, a transfer size calculating module configured to calculate a transfer size conforming to a bus architecture, based on the bus architecture information which is acquired, and a simulation executing module. The simulation executing module sets a transaction converting module configured to convert a transaction from a bus initiator included in the semiconductor integrated circuit into a transaction in a size conforming to the transfer size and output the transaction to the bus, and performs simulation of the semiconductor integrated circuit.

### CROSS-REFERENCE TO RELATED APPLICATION

This application is based upon and claims the benefit of priority from the Japanese Patent Application No. 2011-64630, filed on Mar. 23, 2011, the entire contents of which are incorporated herein by reference.

### FIELD

Embodiments described herein relate generally to a semiconductor integrated circuit simulation apparatus and a simulation method for a semiconductor integrated circuit.

### BACKGROUND

In recent years, a semiconductor integrated circuit called a system LSI (Large Scale Integration) has been widely used. A system LSI is a semiconductor integrated circuit having a plurality of functional blocks and a bus connecting a plurality of functional blocks. A performance of the system LSI significantly depends on a system architecture.

However, the architecture is determined in consideration of a number of elements such as configurations of hardware and a processor which configure a system, a kind and an operation frequency of the processor to be used, to which hardware or processor each process to be executed on the system should be assigned, an execution time of each process which is assigned, and the bus architecture such as a bus width.

A simulation technique is usually used for determination of the architecture. In simulation, with various elements taken into consideration, models which realize a plurality of architectures cited as candidates are operated on simulation apparatuses or actual machines such as breadboards, transaction information on buses, bus use waiting information by bus competition, bus through-put/latency information and the like are obtained, and comparison is made. However, simulation requires much time, and therefore, enhancement in speed of the simulation is required.

In order to enhance the speed of the simulation, simulation is performed, which uses a transaction level interface, that is, a transaction level model (hereinafter, called a TL model) which exchanges data among the functional blocks included in the model collectively as bus transaction information including a data amount and a time taken to transfer the data without using an ordinary pin interface (hereinafter, called a Pin I/F) of an RTL (Register Transfer Level).

TL models are broadly divided into three. That is, a bus initiator model which issues a transaction as a bus master, a bus target model which accepts the transaction as a bus slave, and a bus model which connects the bus initiator model and the bus target model.

When TL models are used in the study of a system architecture, contents of the TL models have to be changed in accordance with the bus architecture which is assumed in some cases. For example, when the bus initiator model issues a transaction to a bus target model, the transaction which is issued or accepted by the TL model of the bus initiator or the bus target is not conforming to the bus architecture in some cases. In such a case, not only the bus model but also the bus initiator model and the bus target model have to be made changeable or rewritable in a form conforming to the bus architecture so as to issue or accept the transaction.

However, it is a complicated work to change the model of a bus initiator or a bus target so that the model is conforming to the bus architecture. It inhibits reduction in simulation time, that is, enhancement in a speed of simulation to change the model of the bust initiator or the bus target at each time so that the model is conforming to a changed bus architecture, each time the bus architecture is changed.

### BRIEF DESCRIPTION OF THE DRAWINGS

FIG. 1 is a configuration view showing a configuration of a semiconductor integrated circuit simulation apparatus according to a first embodiment;

FIG. 2 is a block configuration diagram of a simulation apparatus 1 according to the first embodiment;

FIG. 3 is a diagram showing an example of a transaction level model diagram of a system architecture of a system LSI according to the first embodiment;

FIG. 4 is a diagram for explaining an example of rewrite of a TL model of a bus initiator;

FIG. 5A is a diagram showing an example of a transaction timing chart according to the first embodiment;

FIG. 5B is a diagram showing another example of the transaction timing chart according to the first embodiment;

FIG. 5C is a diagram showing still another example of the transaction timing chart according to the first embodiment;

FIG. 6 is a flowchart showing an example of a division process of a transaction in a transaction converting section 16 according to the first embodiment;

FIG. 7 is a diagram for explaining processing of the transaction converting module which outputs divided transactions, according to the first embodiment;

FIG. 8 is a flowchart showing an example of an integration process of a transaction in the transaction converting section 16 according to the first embodiment;

FIG. 9 is a diagram for explaining a process of the transaction converting module which outputs integrated transactions according to the first embodiment;

FIG. 10 is a transaction level model diagram in which a transaction converting module is provided for each bus initiator, according to the first embodiment;

FIG. 11 is a block diagram of a simulation apparatus 1A according to a second embodiment;

FIG. 12 is a transaction level model diagram of a system architecture of a system LSI, according to the second embodiment;

FIG. 13 is a flowchart showing an example of a division process of a transaction in a transaction converting section 16A, according to the second embodiment;

FIG. 14 is a diagram for explaining a process of the transaction converting section 16A which outputs divided transactions, according to the second embodiment;

FIG. 15 is a flowchart showing an example of an integration process of a transaction in the transaction converting section 16A, according to the second embodiment;

FIG. 16 is a diagram for explaining a process of the transaction converting module which outputs an integrated transaction, according to the second embodiment;

FIG. 17 is a transaction level model diagram in which a transaction converting module is provided for each bus target, according to the second embodiment; and

FIG. 18 is a transaction level model diagram of a system architecture of a system LSI, according to a third embodiment.

### DETAILED DESCRIPTION

A semiconductor integrated circuit simulation apparatus of an embodiment has a bus architecture information acquiring module configured to acquire bus architecture information of a bus included in a semiconductor integrated circuit, a transfer size calculating module configured to calculate a transfer size conforming to the bus architecture, based on the bus architecture information which is acquired, and a simulation executing module. The simulation executing module sets a transaction converting module configured to convert a transaction from a bus initiator included in the semiconductor integrated circuit into a transaction in a size conforming to the transfer size and output the transaction to the bus, and performs simulation of the semiconductor integrated circuit.

A simulation method for a semiconductor integrated circuit of an embodiment is a method for performing simulation of the semiconductor integrated circuit by using a bus architecture information acquiring module, a transfer size calculating module and a simulation executing module, and has acquiring bus architecture information of a bus included in the semiconductor integrated circuit, by the bus architecture information acquiring module, calculating a transfer size conforming to the bus architecture, based on the bus architecture information which is acquired, by the transfer size calculating module, and performing simulation of the semiconductor integrated circuit by setting a transaction converting module configured to convert a transaction from a bus initiator included in the semiconductor integrated circuit into a transaction in a size conforming to the transfer size and output the transaction to the bus, by the simulation executing module.

Hereinafter, embodiments will be described with reference to the drawings.

### FIRST EMBODIMENT

### (Configuration)

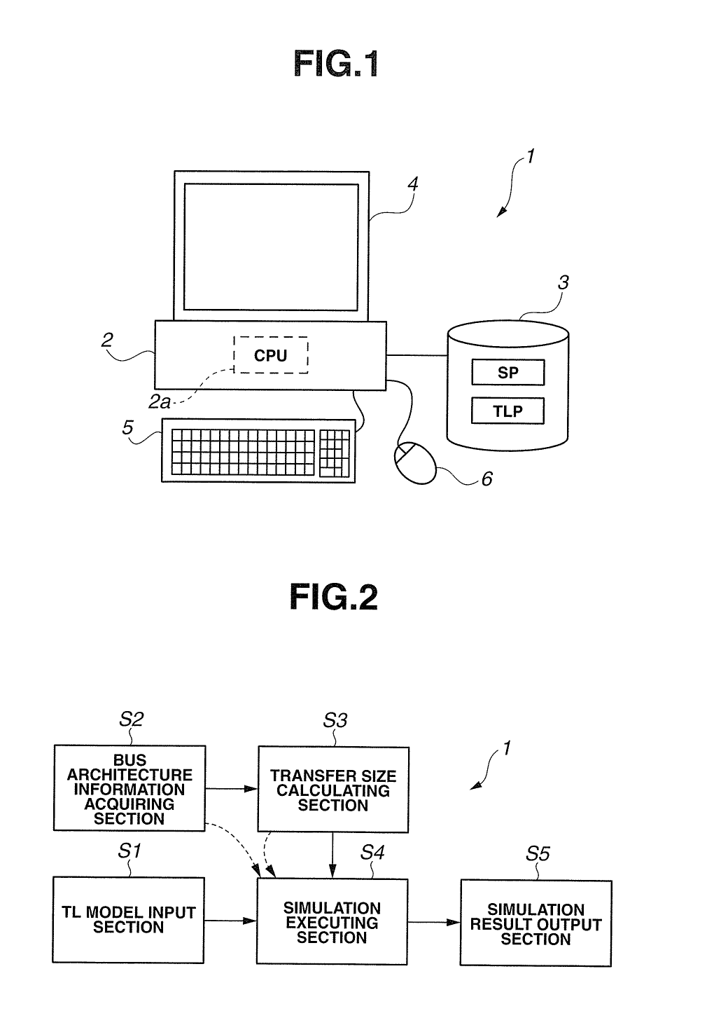

FIG. 1 is a configuration view showing a configuration of a semiconductor integrated circuit simulation apparatus (hereinafter, called a simulator apparatus) according to the present embodiment. A simulation apparatus 1 is configured by having a main body apparatus 2 having a central processing unit (hereinafter, called CPU) 2a configured to execute various software programs, a storage unit 3 configured to store various software programs and the like by being connected to the main body apparatus 2, and a display unit 4 connected to the main body apparatus 2. Input equipment of a keyboard 5 and a mouse 6 is connected to the main body apparatus 2 for a user to give an instruction to execute various programs.

The storage unit 3 stores a simulation program SP configured to perform simulation of a semiconductor integrated circuit, and transaction level model data, that is, a program (hereinafter, called a TL model program) TLP, as various software programs. The CPU 2a of the main body apparatus 2 executes the simulation program SP with respect to the TL model program TLP stored in the storage unit 3 in response to the instruction of a user who is a system architecture studying operator.

Accordingly, a user creates the TL model program TLP of a semiconductor integrated circuit, executes the simulation program SP and can perform simulation of the semiconductor integrated circuit which the user designs.

FIG. 2 is a block configuration diagram of the simulation apparatus 1. Each block of FIG. 2 is realized by processing of the simulation program SP. Processing of the simulation program SP is executed by the CPU 2a.

As shown in FIG. 2, the simulation apparatus 1 has a TL model input section S1, a bus architecture information acquiring section S2, a transfer size calculating section S3, a simulation executing section S4 and a simulation result output section S5.

First, a user inputs or designates the TL model program TLP which is an object of simulation by using the input equipment such as the keyboard 5. The CPU 2a inputs information of each TL model from the designated TL model program TLP, and retains the information in a RAM or the like. The TL model input section S1 is a processing module in which each TL model is inputted.

Next, the user inputs and sets bus architecture information of a bus 15. The CPU 2a acquires the set bus architecture information and retains the bus architecture information in the RAM or the like as data for subsequent processing. Here, the information of the bus width of the bus, a burst length and time taken for transfer which the user designates is set. The bus architecture information acquiring section S2 is a processing module which acquires the bus architecture information of the bus which is included in a semiconductor integrated circuit.

The CPU 2a obtains a transfer size of transaction data outputted by a transaction converting module which will be described later by operation from the set information of the bus architecture. The transfer size calculating section S3 is a processing module which calculates a transfer size conforming to the bus architecture based on the acquired bus architecture information.

As will be described later, the transaction converting module divides or integrates transaction data and outputs the transaction data in the set transfer size to the bus. The CPU 2a performs simulation of the TL model program TLP including the transaction converting module disposed between the bus initiator and the bus. The simulation executing section S4 is a processing module configured to perform simulation of a semiconductor integrated circuit by setting the transaction converting module (which will be described later) configured to convert the transaction from the bus initiator included in the semiconductor integrated circuit into a transaction in a size conforming to a transfer size and output the transaction to the bus.

The CPU 2a outputs a simulation result and displays the simulation result on the screen of the display apparatus 4. The simulation result is, for example, a transaction timing chart or the like. The simulation result output section S5 is a processing module configured to output the result of the simulation by the simulation executing section S4.

In the present embodiment, an example in which setting of information of the bus architecture and calculation of the transfer size are performed before execution of simulation, but as shown by dotted lines, setting and change of the information of the bus architecture (S2) and calculation of the transfer size based on the setting and the like (S3) may be performed in execution of the simulation (S4).

Next, an example of the transaction level model will be described.

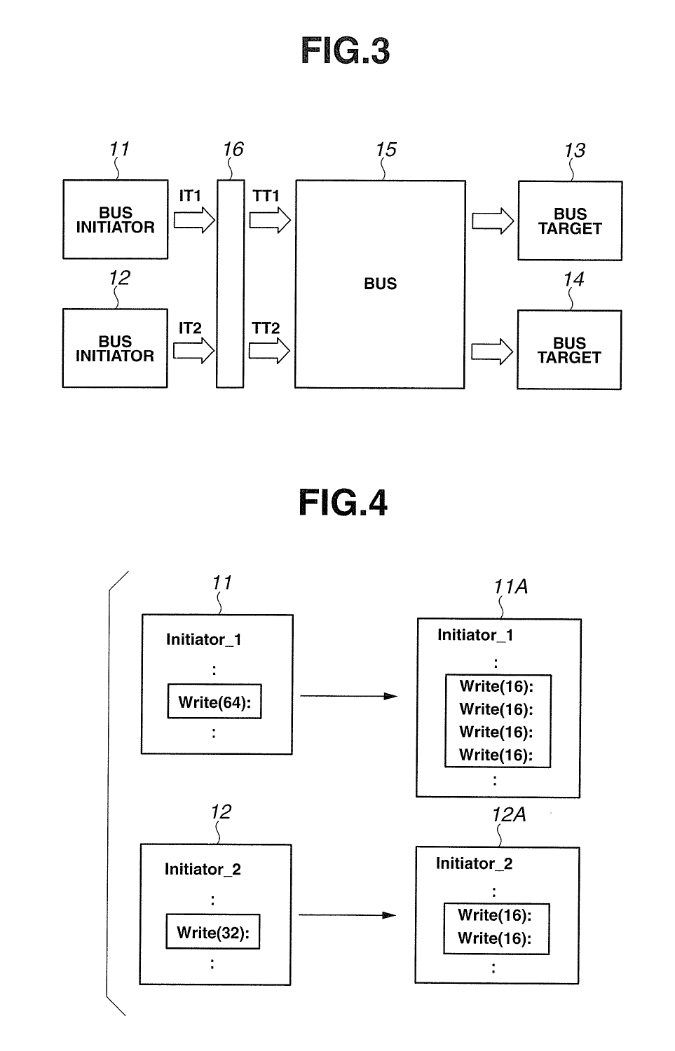

FIG. 3 is a diagram showing an example of a transaction level model diagram of system architecture of a system LSI. The transaction level model diagram is a diagram showing the architecture of the system LSI which is used at the time of simulation. In general, in the system LSI, a plurality of functional blocks are connected through one or a plurality of buses, and the plurality of functional blocks exchange data through predetermined one or a plurality of buses, but in FIG. 3, for simplification of the description of the present embodiment, four functional blocks and only one bus that connects the blocks are shown. A unit of a transfer process of data relating to read or write of the data is a transaction.

In FIG. 3, as an example, bus initiators 11 and 12, and bus targets 13 and 14 are connected via a bus 15. The four functional blocks have a processing condition that the bus initiator 11 transmits a predetermined transaction IT1 to the bus target 13 from a predetermined time, the bus initiator 12 also transmits a predetermined transaction IT2 to the bus target 14 from a time different from the aforesaid predetermined time, and a predetermined process is executed in each of the bus targets 13 and 14.

For example, the bus initiator 11 is a TL model configured to transmit the transaction IT1 of 64 bytes to the bus target 13 via the bus 15 from a predetermined time t1, and the bus target 13 which receives data from the bus initiator 11 is a TL model having an operation condition of executing a predetermined process at a time point at which the bus target 13 has received the entire transaction of 64 bytes. Likewise, the bus initiator 12 is a TL model configured to transmit the transaction IT2 of 32 bytes to the bus target 14 via the bus 15 from a predetermined time t2, and the bus target 14 is a TL model having the operation condition of executing a predetermined process at a time point at which the bus target 14 has received the entire transaction of 32 bytes. The bus 15 is a TL model of bus architecture having a designated bus width and a designated burst length.

For example, a case is assumed, in which a user performs simulation by setting the bus width of the bus 15 at 32 bits, and the burst length at four. Since the bus 15 has a width of 32 bits and the burst length of four, the bus initiators 11 and 12 cannot output transactions of 64 bytes and 32 bytes directly to the bus 15 respectively.

Conventionally, the content of the TL model of the bus initiator 11 is rewritten, and has to be rewritten to the TL model in which the transaction of 64 bytes is divided into four transactions of 16 bytes to be transmitted. Similarly, the TL model of the bus initiator 12 is also rewritten, and has to be rewritten to the model in which the transaction of 32 bytes is divided into two transactions of 16 bytes to be transmitted.

FIG. 4 is a diagram for explaining an example of rewrite of the TL model of the bus initiator. As shown in FIG. 4, when the bus initiators 11 and 12 describe transaction processes of 64 bytes and 32 bytes respectively, the bus initiators 11 and 12 have to be respectively rewritten to bus initiators 11A and 12A which issue transactions of 16 bytes in accordance with the bus architecture. Further, in order to study the system architecture of the system LSI, when the bus architecture is changed, the user who is an operator of the system architecture study, has to rewrite the TL models of the bus initiators 11 and 12 to the TL models of the bus initiators 11A and 12A in accordance with the changed bus architecture.

In the present embodiment, in order that such rewrite or correction of the model does not have to be performed, a transaction converting section 16 which is provided between the bus initiators 11 and 12, and the bus 15 is set, and the transaction converting section 16 is configured to convert the inputted transactions IT1 and IT2 into transactions TT1 and TT2 which are converted into predetermined sizes and output the transactions TT1 and TT2.

The transaction converting section 16 is a TL model which is provided only at a simulation time, and the transaction converting section 16 is not included in the system LSI which is finally manufactured.

Further, in order that the time required for processing in the transaction converting section 16 is not reflected in the simulation result of the TL model program TLP, the simulation result is generated and outputted with the processing time in the transaction converting section 16 being excluded. For example, the execution start timing of the processing in each of the bus initiators 11 and 12, the bus 15 and the bus targets 13 and 14 is determined with the processing time in the transaction converting section 16 being excluded, and a transaction timing chart is created.

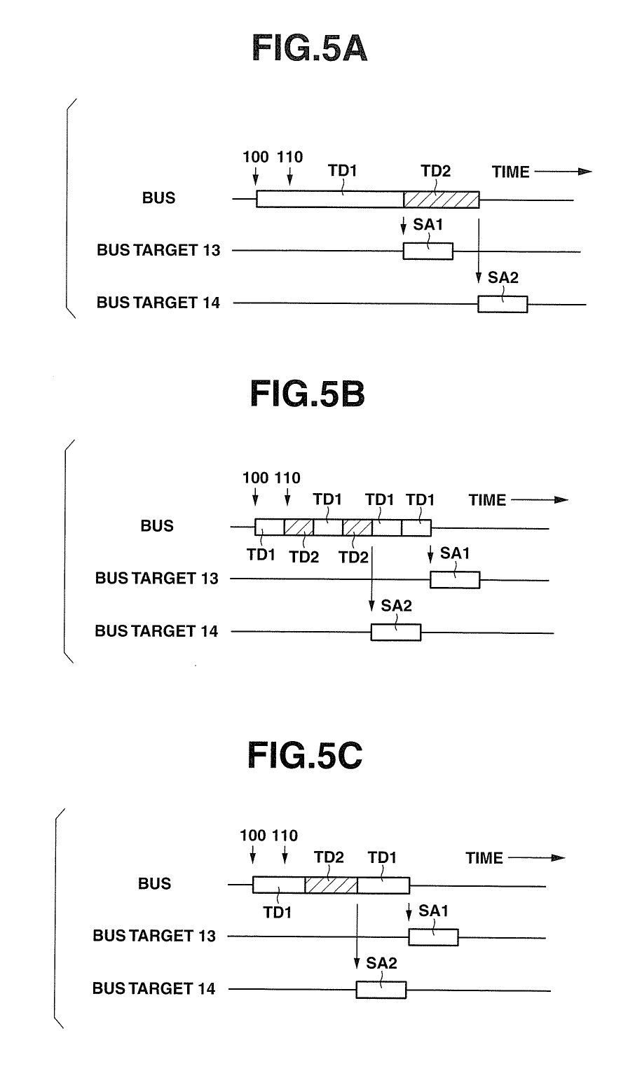

Here, the transaction timing chart will be described. FIGS. 5A to 5C are diagrams showing examples of the transaction timing chart. FIGS. 5A to 5C each show a case in which the bus initiator 11 transmits data TD1 of 64 bytes to the bus target 13 at a time 100, the bus target 13 executes a process SA1 after having all of the data of 64 bytes, the bus initiator 12 transmits data TD2 of 32 bytes to the bus target 14 at a time 110, and the bus target 14 executes a process SA2 after having all of the data of 32 bytes.

The example of FIG. 5A is a method which does not give consideration to a width of the bus, a burst length and a bus arbitration, and the bus initiator 11 issues a collective transaction of 64 bytes at the time 100. Next, the bus initiator 12 issues a collective transaction of 32 bytes at the time 110, but since the bus is occupied by the transaction by the bus initiator 11, the bus initiator 12 waits until the transaction by the bus initiator 11 is completed. After the bus becomes vacant, the transaction by the bus initiator 11 is issued to the bus. FIG. 5A shows the transaction timing in such a case.

In an example of FIG. 5B, the bus has a width of 32 bits, and a burst length of four, and bus arbitration is of a round robin method. In this case, as for the transaction of 64 bytes issued from the bus initiator 11, four-burst transfer of 16 bytes is issued four times in accordance with the bus architecture, and as for the transaction of 32 bytes which is issued from the bus initiator 12, four-burst transfer of 16 bytes is issued twice in accordance with the bus architecture. This is the case in which the bus initiator 11 starts transfer of the data TD1 of 16 bytes to the bus target 13 from the time 100, the bus target 13 executes the process SA1 after having all of the data of 64 bytes, the bus initiator 12 starts transfer of the data TD2 of 16 bytes to the bus target 14 from the time 110, and the bus target 14 executes the process SA2 after having all of the data of 32 bytes. FIG. 5B shows the transaction timing in such a case. It is found that the second and the subsequent TD1 and TD2 both wait for vacancy of the bus, and as soon as the bus becomes vacant, the transaction is issued, but since bus arbitration is of round robin, in the timing at which both TD1 and TD2 are waiting, the transaction is issued in sequence. If the bus width becomes small, the data amount which can be transferred in the same time becomes small, and therefore, the transfer time of data becomes long.

In an example of FIG. 5C, the bus has a width of 64 bits, and a burst length of four, and the bus arbitration is of a round robin method. In this case, as for the transaction of 64 bytes which is issued from the bus initiator 11, a transaction of 32 bytes with four-burst transfer is issued twice in accordance with the bus architecture, and as for the transaction of 32 bytes which is issued from the bus initiator 12, four-burst transfer is performed once in accordance with the bus architecture. This is the case in which the bus initiator 11 starts transfer of the data TD1 of 32 bytes to the bus target 13 from the time 100, the bus target 13 executes the process SA1 after having all of the data of 64 bytes, the bus initiator 12 starts transfer of the data TD2 of 32 bytes to the bus target 14 from the time 110, and the bus target 14 executes the process SA2 after having all of the data of 32 bytes. FIG. 5C shows the transaction timing in such a case. It is found that the second and the subsequent TD1 and TD2 both wait for vacancy of the bus, and as soon as the bus becomes vacant, the transaction is issued, but since the bus arbitration is of round robin, the transaction is issued in sequence in the timing at which both of TD1 and TD2 are waiting.

As above, the transaction timing chart shows execution of each transaction in accordance with the bus architecture, and the situation of the execution start timing in each of the bus targets, and therefore, timing at a time of change of the bus architecture can be easily grasped.

### (Division of Transaction)

First, an example of a case in which the transaction converting section 16 of FIG. 3 divides each of the transactions issued from the bus initiators 11 and 12 into transactions each of a transfer size corresponding to the bus architecture of the bus 15 will be described.

The bus architecture information for simulation is inputted by a user, and the transaction converting section 16 divides the transactions IT1 and IT2 from the bus initiators 11 and 12 in each transfer size calculated from the bus architecture information of the bus 15 which is acquired in S2, and outputs a plurality of divided transactions DT to the bus 15. More specifically, since the transaction converting section 16 converts the transactions IT1 and IT2 which are issued collectively from the bus initiators into the transfer size corresponding to the bus architecture, change of the TL model of the bus initiator is not required.

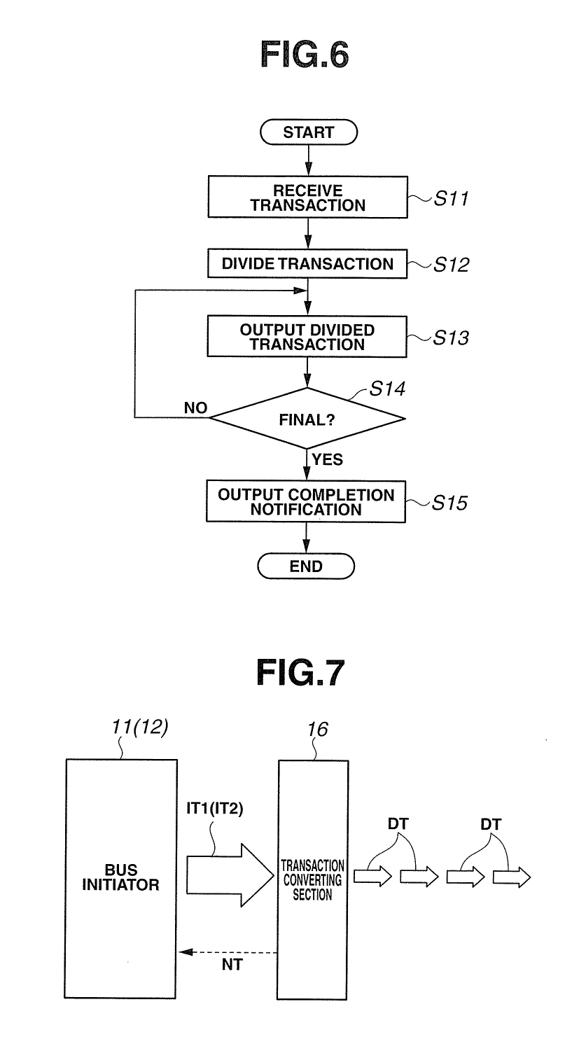

FIG. 6 is a flowchart showing an example of a division process of the transaction in the transaction converting section 16.

The transaction converting section 16 receives a transaction from the bus initiator 11 (S11), and executes a transaction conversion process of performing conversion of dividing the transaction from the bus initiator 11 in a transfer size TS which the bus architecture allows and is obtained in S3 (S12).

The transfer size TS is obtained from the bus width and the burst length which the bus architecture information indicates. In the case of the aforementioned example, in a case of a bus width of 32 bits and a burst length of four, a transfer size (that is, an expected size) of the bus 15 is 16 bytes (=4 Byte(32 bit)×4 burst). Accordingly, when the transaction size IT1 of the bus initiator is 64 bytes, the transfer size TS is 16 bytes, and therefore, the transaction IT1 is divided into four.

By the processing of S12, the transaction from the bus initiator 11 is divided into a plurality of transactions (S12), which are outputted one by one (S13). When the transaction divided (hereinafter, called the divided transaction) is outputted, whether it is a final divided transaction or not is determined (S14).

FIG. 7 is a diagram for explaining a process of the transaction converting module which outputs divided transactions. In FIG. 7, the transaction IT1 of 64 bytes from the bus initiator 11 is divided into four transactions DT each having a transfer size of 16 bytes.

Until a fourth divided transaction DT is outputted, a determination result in S14 is NO, S13 is repeated, and output of the divided transactions DT is performed. When the fourth divided transaction DT is outputted, the determination result in S14 becomes YES, completion notification NT is outputted to the bus initiator 11 (S15), and the processing is finished.

More specifically, when the size of the transaction from the bus initiator 11 is larger than the transfer size TS, the transaction converting section 16 divides the transaction from the bus initiator 11 into transactions each in the transfer size TS to generate a plurality of divided transactions, and outputs a plurality of divided transactions to the bus 15. Subsequently, the transaction converting section 16 checks completion of the transactions corresponding to 64 bytes which the bus initiator 11 expects, and if the transactions are completed, the transaction converting section 16 notifies the bus initiator 11 of completion of issue of the expected transactions. By the completion notification from the transaction converting section 16, the bus initiator 11 determines completion of the issue of the transactions, and can perform issue of a next transaction.

The bus initiator 11 is described above, and in the case of the bus initiator 12, the transaction IT2 is of 32 bytes, and therefore, the transaction converting section 16 divides the transaction IT2 into two divided transactions DT and output the two divided transactions DT.

### (Integration of Transactions)

The above is the case in which the sizes of the transactions IT1 and IT2 which are issued by the bus initiators are larger than the transfer size TS of the bus 15, and there is a case in which the sizes of the transactions IT1 and IT2 which are issued by the bus initiators are smaller than the transfer size TS of the bus 15.

In such a case, the transaction converting section 16 performs integration of the transactions which are issued from the bus initiator.

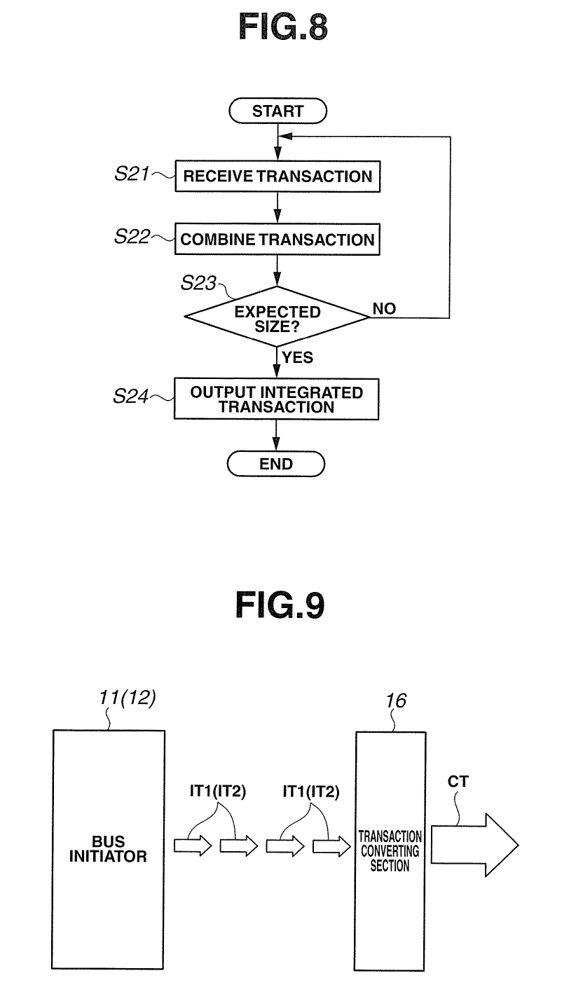

FIG. 8 is a flowchart showing an example of an integration process of transactions in the transaction converting section 16.

The transaction converting section 16 receives a transaction from the bus initiator 11 (S21), and executes a transaction conversion process of performing conversion of combining, namely, integrating the transaction from the bus initiator 11 (S22) so as to achieve the transfer size TS which is allowed by the bus architecture and is obtained in S3 (S22).

The CPU 2a determines whether or not the integrated transaction is in the transfer size TS (namely, the expected size) of the bus 15 (S23), and if the integrated transaction is not in the expected size (S23: NO), the process returns to S21. If the integrated transaction is in the expected size (S23: YES), a transaction integrated (hereinafter, called an integrated transaction) CT is outputted, that is, issued to the bus 15 (S24).

Accordingly, by the processing of S21, S22 and S23, the transaction IT1 from the bus initiator 11 is integrated, and the integrated transaction CT in the transfer size TS is outputted.

FIG. 9 is a diagram for explaining a process of the transaction converting module which outputs an integrated transaction. As described above, the transfer size TS is obtained from the bus width and the burst length which the bus architecture information indicates. For example, when the bus width is of 32 bits and the burst length is eight, the transfer size of the bus 15 is 64 bytes. When the transaction size IT1 issued by the bus initiator 11 is 16 bytes, the transfer size TS is 64 bytes, and therefore, four transactions IT1 are integrated. The four transactions IT1 are integrated, and an integrated bus transaction CT in the transfer size of 64 bytes is outputted.

Until a fourth transaction IT1 is outputted, a determination result is NO in S23, S21 and S22 are repeated, and the transactions IT1 are integrated. When the four transactions IT1 are received, the determination result becomes YES in S23, and the integrated transaction CT is outputted to the bus 15.

More specifically, when the size of the transaction IT1 from the bus initiator 11 is smaller than the transfer size TS, the transaction converting section 16 integrates the transactions from the bus initiator 11 to make a transaction in the transfer size TS to generate one integrated transaction CT, and outputs the integrated transaction CT to the bus 15.

The bus initiator 11 is described above, and in a case of the bus initiator 12, integration of a plurality of transactions is similarly performed when the transfer size of the bus is larger than the size of a transaction.

As above, according to the simulation apparatus of the present embodiment which can perform conversion (division or integration) of a transaction, if information of the bus architecture is set, simulation of designated TL model can be performed even if a user who is a system architecture studying operator does not make correction such as rewrite of a TL model of a bus initiator.

The simulation executing section (S4) can determine execution start timing of processing in the bus target included in a semiconductor integrated circuit based on output time information of the converted transaction which is obtained in the simulation. More specifically, the time information of the output time of each transaction to the bus 15, for example, the aforementioned time 100 and time 110, and the like can be obtained, and therefore, the simulation executing section (S4) can determine the execution start timing of a predetermined process in the bus target by using the obtained time information. Accordingly, the simulation result output section (S5) can generate a transaction timing chart or the like from the information of the execution start timing and output the transaction timing chart or the like.

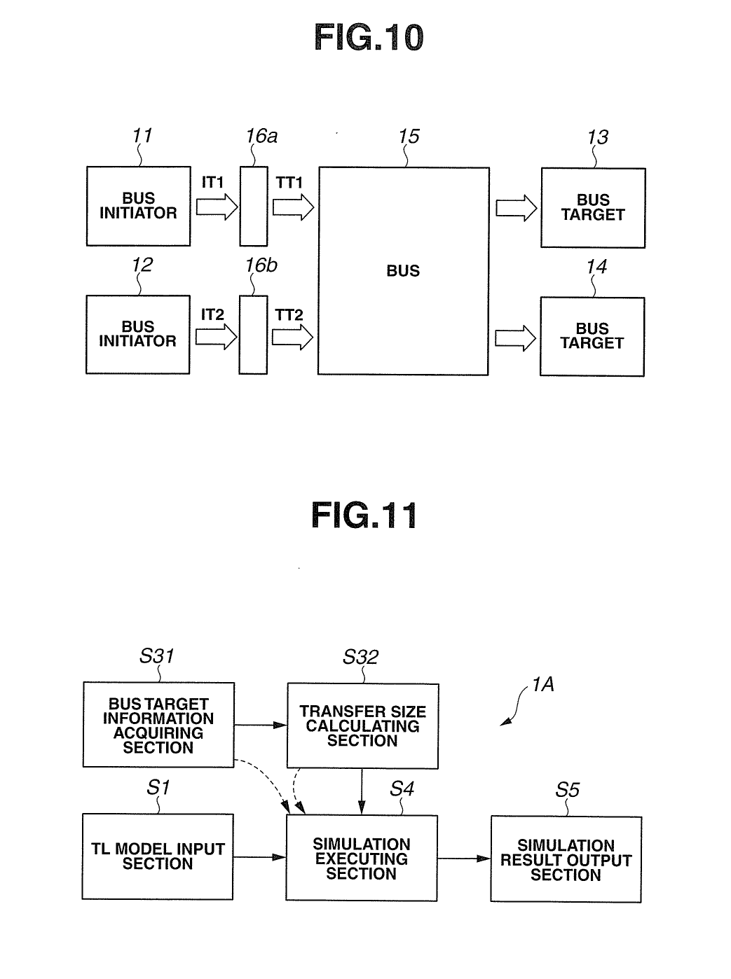

In the above described example, one transaction converting section 16 is provided for the bus, but the transaction converting module may be provided at each bus initiator. FIG. 10 is a transaction level model diagram in which a transaction converting module is provided for each bus initiator. As shown in FIG. 10, transaction converting sections 16a and 16b are provided to correspond to the bus initiators 11 and 12, respectively.

Furthermore, in the above described example, when the size of the transaction from the bus initiator is larger than the transfer size TS, the transaction from the bus initiator is divided, and is issued to the bus target through the bus, but calculation processing of the transfer time of the transaction is performed, and the transaction may be supplied as it is directly to the bus target through the bus without division of the transaction from the bus initiator.

More specifically, in division of a transaction, division of data included in the transaction is not performed, and only calculation of information of how many transactions are created by division of the transaction, and when the transactions are outputted is performed. For example, when a transaction is divided into four, the transaction converting section (S4) does not perform division of the transaction from the bus initiator, but calculates and obtains each of virtual output times (time information such as the aforementioned time 100 and time 110) of the four divided transactions.

This can save the time taken for division and transfer processing of the transaction itself in the simulation process, and therefore, provides an advantage of leading to enhancement in speed of simulation. The number of divisions of the transaction is calculated, only calculation of a transfer time of each of the divided transactions by bus arbitration is performed, and a calculation result can be obtained. Therefore, the execution start timing of the processing in the bus target can be determined Accordingly, the simulation result can be obtained similarly to the above description.

For example, when the bus initiator issues a transaction of 16 bytes, the transaction is “0×AABBCCDDEEFFGGHH”, and the bus architecture has a 32-bit width with only single transfer (more specifically, a transaction size of one time is four-byte transfer), the transaction is divided into four. At this time, the calculation process of the number of divisions of the transaction, and the division process of the transaction data into “0×AABB”, “0×CCDD”, “0×EEFF” and “0×GGHH” are usually performed, but in this case, only the calculation process of the number of divisions of the transaction is performed, the division process of the transaction is not performed, and transfer of the transaction data “0×AABBCCDDEEFFGGHH” of 16 bytes is performed. Since transfer of the transaction data “0×AABBCCDDEEFFGGHH” to the bus target is performed, there is no problem in the processing in the bus target.

As above, when the size of the transaction from the bus initiator is larger than the transfer size, the transaction converting module creates virtual output time information in a case of the transaction from the bus initiator being divided into transactions of the transfer size and outputted, outputs the transaction from the bus initiator as it is directly to the bus, and does not execute the division process of the transaction.

More specifically, the simulation executing section (S4) obtains the virtual output time of the divided transactions in a case of assuming that the transaction is divided by calculation, and determines an execution start timing of processing in the bus target included in the semiconductor integrated circuit based on the virtual output time information of the converted transaction which is obtained in simulation.

As above, even when exchange of a transaction and calculation of timing time are separately performed, simulation can be executed without rewrite of the TL model of the bus initiator, as in the aforementioned embodiment.

### SECOND EMBODIMENT

The first embodiment relates to the simulation apparatus which does not have to rewrite the TL model of the bus initiator even when the bus architecture is changed, but the present embodiment relates to a simulation apparatus which does not have to rewrite the TL model of a bus target even when the bus architecture is changed.

In the TL model of a bus target, the operation start condition for receiving a transaction and starting a process is defined, that is, described in some cases, and rewrite of the TL model is needed in accordance with change of the bus architecture, in some cases.

For example, if a certain bus target has a specification capable of receiving only a transaction in a predetermined size, an intended process is not executed in some cases. Alternatively, if a certain bus target has a specification in which reception of a transaction is an operation start condition of a process, even when the bus target receives a part of the transaction (for example, 16 bytes in 64 bytes) in a predetermined size, a process using the part of the transaction is started, and an intended process is not executed or an unintended process is executed in some cases. Accordingly, rewrite of the TL model of the bus target has been conventionally needed.

Thus, according to the present embodiment, when a user changes the bus architecture, the transaction converting module converts a transaction in accordance with the bus target information.

FIG. 11 is a block configuration diagram of a simulation apparatus 1A. Each of blocks in FIG. 11 is realized by processing of a simulation program SP. In FIG. 11, the same processes as those of FIG. 2 are assigned with the same reference numerals and characters, and description thereof will be omitted.

FIG. 11 is a block configuration diagram of the simulation apparatus 1A. The simulation apparatus 1A has a TL model input section S1, a bus target information acquiring section S31, a transfer size calculating section S32, a simulation executing section S4 and a simulation result output section S5.

In FIG. 11, bus target information is inputted by a user, and therefore, after S1, acquisition of bus target information is performed (S31). Subsequently, from the bus target information, an expected size of each bus target is obtained by calculation (S32), and simulation is executed (S4).

As shown by dotted lines, in execution of simulation (S4), setting and change of the bus target information (S31) and calculation of the transfer size (S32) based on the setting and the like may be performed.

The bus target information acquiring section S31 is a processing module which acquires bus target information including a start condition with which the bus target included in a semiconductor integrated circuit accepts a transaction and starts an operation. The transfer size calculating section S32 is a processing module which calculates a transfer size for a bus target which is conforming to the bus target based on the acquired bus target information.

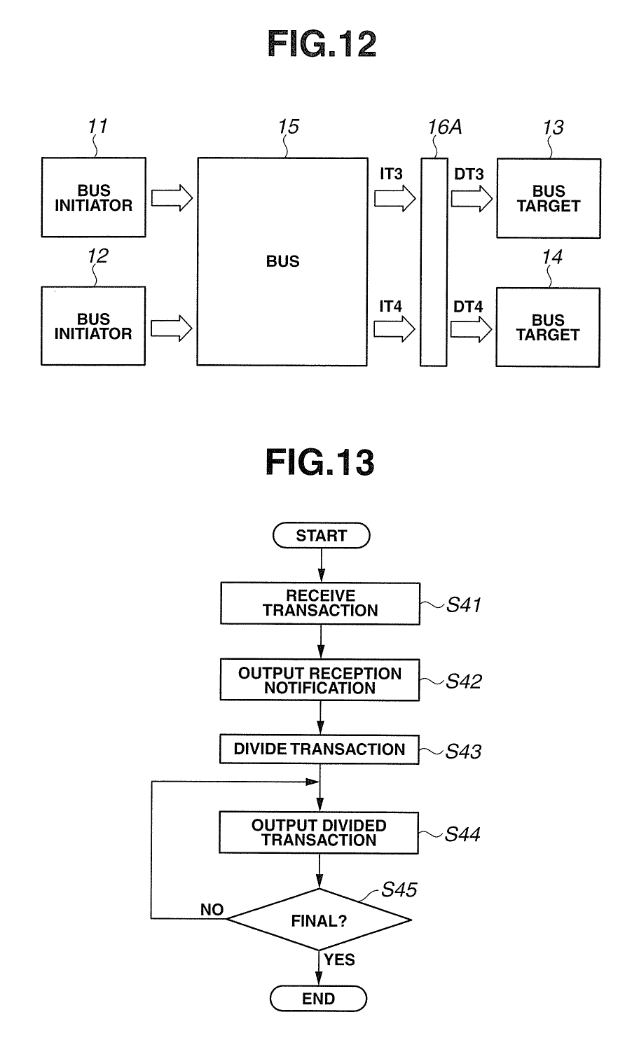

FIG. 12 is a transaction level model diagram of a system architecture of a system LSI, according to the second embodiment. As shown in FIG. 12, a transaction converting section 16A is set between a bus 15 and bus targets 13 and 14. The configuration of the simulation apparatus of the second embodiment is the same as the simulation apparatus 1 of the first embodiment described with FIGS. 1 and 2, and in the transaction level model diagram of the present embodiment shown in FIG. 12, the same components as those in FIG. 3 are assigned with the same reference numerals and characters, and description thereof will be omitted.

In a case shown in FIG. 12, from inputted bus architecture information (S31), the operation start condition of each of the bus targets and the like, an expected size which is a transfer size is determined (S32). Subsequently, simulation of a TL model program TLP including the transaction converting module disposed between the bus and the bus targets is performed by a CPU 2a (S4).

### (Division of Transaction)

First, an example of a case in which the transaction converting section 16A in FIG. 12 divides each of the transactions received from the bus 15 into transactions in an expected size of each of the bus targets 13 and 14 will be described. The expected sizes of the bus targets 13 and 14 are the sizes of the transactions which are set based on operation start conditions with which the bus targets 13 and 14 receive the transactions and start processes.

The bus architecture information for simulation is inputted by a user. The transaction converting section 16A divides bus transactions IT3 and IT4 from the bus 15 in each expected size calculated from the bus architecture information and each bus target information which is acquired in S31, and outputs a plurality of divided transactions DT3 and DT4 respectively to the bus targets 13 and 14. More specifically, the transaction converting section 16A converts the transactions IT3 and IT4 from the bus 15 into the transfer sizes corresponding to the bus targets 13 and 14 without changing the TL models of the bus targets.

FIG. 13 is a flowchart showing an example of the division process of the transaction in the transaction converting section 16A.

The transaction converting section 16A receives a transaction from the bus 15 (S41), and upon reception, outputs acceptance notification NT1 of the transaction to the bus 15 (S42). The transaction converting section 16A executes a transaction conversion process of performing conversion of dividing the transaction from the bus 15 into a transfer size TS in the expected size which each of the bus targets allows and is obtained in S32 (S43).

The transfer size TS is the expected size of each of the bus targets as described above. For example, when a bus width is 32 bits and a burst length is eight, the transfer size of the bus 15 is 64 bytes. In contrast with this, when an expected size of the bus target 13 is 16 bytes, the transaction from the bus 15 is divided into four divided transactions DT3.

Subsequently, the transaction from the bus 15 is divided into a plurality of transactions, which are outputted one by one (S44). When the divided transaction is outputted, whether it is a final divided transaction or not is determined (S45).

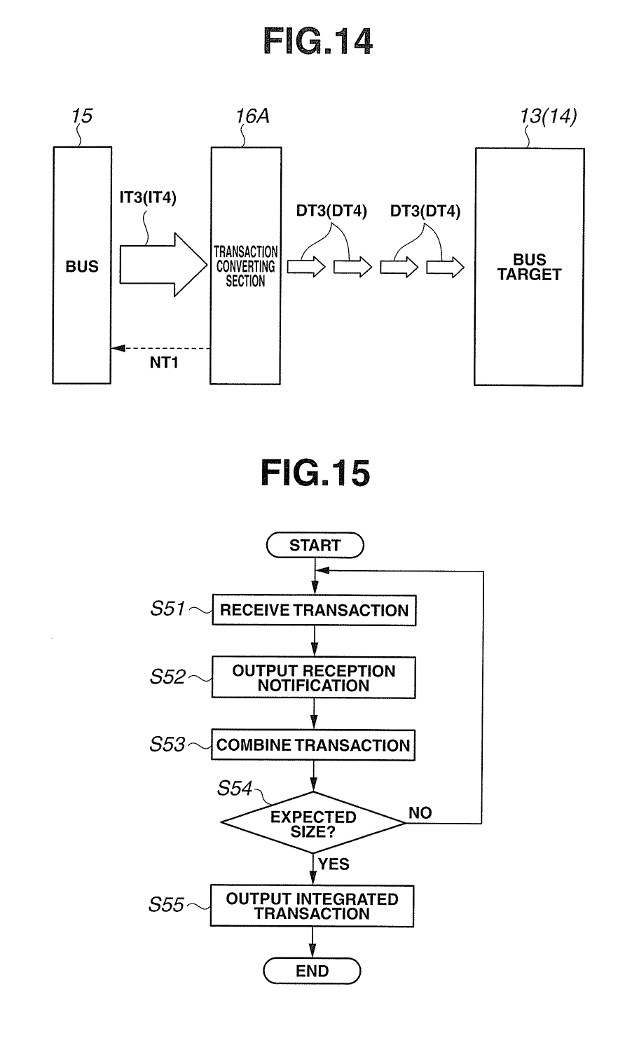

FIG. 14 is a diagram for explaining a process of the transaction converting section 16A which outputs divided transactions. As shown in FIG. 14, the transaction IT3 of 64 bytes from the bus 15 is divided into four divided transactions DT3 each having a transfer size of 16 bytes.

Until a fourth divided transaction DT3 is outputted, a determination result of S45 is NO, S44 is repeated, and the divided transactions DT3 are outputted. When the fourth divided transaction DT3 is outputted, the determination result in S45 becomes YES, and the processing is finished.

More specifically, when the size of the transaction from the bus 15 is larger than the expected size, the transaction converting section 16A divides the transaction from the bus 15 into transactions each in the transfer size TS which is the expected size to generate a plurality of divided transactions DT3, and outputs a plurality of divided transactions DT3 to the bus target 13.

The bus target 13 is described above, and in the case of the bus target 14, the transaction converting section 16A also divides the transaction from the bus 15 into the expected size of the bus target 14 and outputs the transactions to the bus target 14.

### (Integration of Transactions)

The above is the case in which the sizes of the transactions IT3 and IT4 from the bus 15 are larger than the expected sizes of the bus targets, and there is a case in which the sizes of the transactions IT3 and IT4 from the bus 15 are smaller than the expected sizes of the bus targets 13 and 14.

In such a case, the simulation program SP performs integration of the transactions from the bus.

FIG. 15 is a flowchart showing an example of an integration process of transactions in the transaction converting section 16A.

The transaction converting section 16A receives a transaction from the bus 15 (S51), and upon reception, outputs acceptance notification of the transaction to the bus 15 (S52). The transaction converting section 16A executes a transaction conversion process of performing conversion of integrating the transactions from the bus 15 (S15) so that the transaction is in the expected size of the bus target obtained in S3 (S53).

The CPU 2a determines whether or not the integrated transaction is in the expected size of the bus target 13 (S54), and if the integrated transaction is not in the expected size (S54: NO), the process returns to S51. If the integrated transaction is in the expected size (S54: YES), the integrated transaction CT3 is outputted, that is, issued to the bus target 13 (S55).

Accordingly, by the processes of S51, S53 and S54, the transaction IT3 from the bus 15 is integrated, and the integrated transaction CT3 in the expected size of the bus target 13 is outputted.

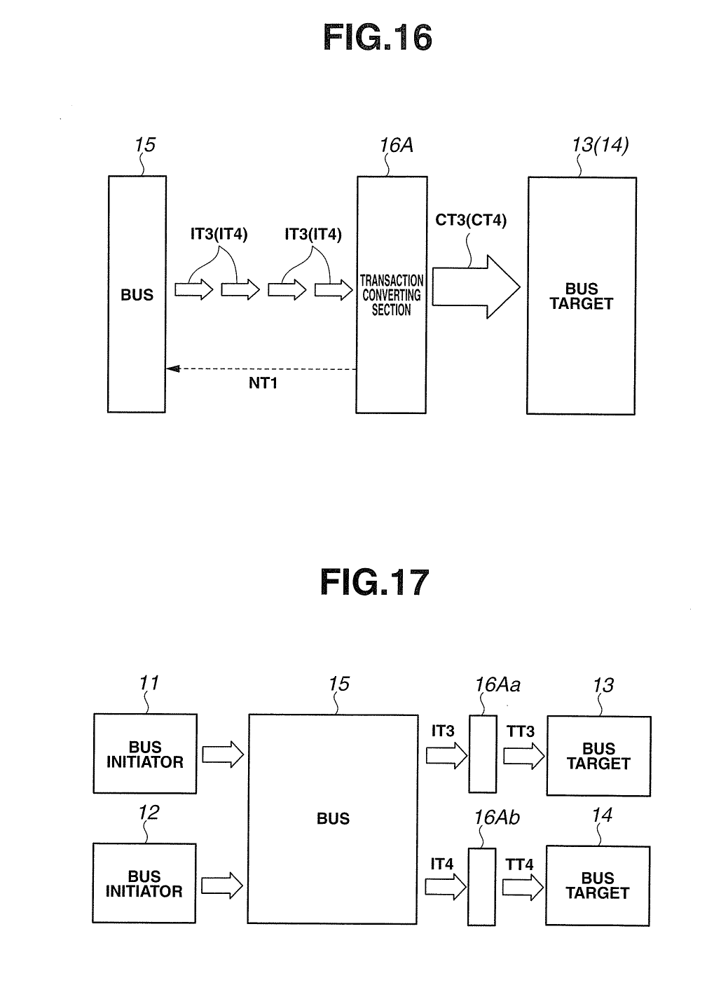

FIG. 16 is a diagram for explaining a process of the transaction converting module which outputs an integrated transaction. As described above, the expected size can be acquired from the TL model of the bus target 13. For example, when the size of the transaction from the bus 15 is 16 bytes, and the expected size of the bus target 13 is 64 bytes, four of the transactions IT3 are integrated, since the expected size is 64 bytes. The four transactions IT3 are integrated, and the integrated transaction CT3 of 64 bytes is outputted.

Accordingly, until the four transactions IT3 are integrated, a determination result is NO in S54, S51 to S53 are repeated, and the transactions IT3 are integrated. When the four transactions IT3 are received, the determination result becomes YES in S54, and the integrated transaction CT3 is outputted to the bus target 13.

More specifically, when the size of the transaction IT3 from the bus 15 is smaller than the transfer size which is the expected size, the transaction converting section 16A integrates the transactions IT3 from the bus 15 to make the transaction in the transfer size to create one integrated transaction CT3, and outputs the integrated transaction CT3 to the bus target 13.

The above is the description of the bus target 13. The same thing applies to the case of the bus target 14, and the transaction converting section 16A outputs an integrated transaction CT4 to the bus target 14.

Subsequently, the simulation executing section (S4) can determine an execution start timing of the processing in the bus target included in the semiconductor integrated circuit based on output time information of the converted (divided or integrated) transaction which is obtained in simulation. More specifically, time information of the output time of each of the transactions from the bus 15, for example, the aforementioned time 100, time 110 and the like can be obtained, and therefore, the simulation executing section (S4) can determine the execution start timing of a predetermined process in the bus target by using the obtained time information. Accordingly, the simulation result output section (S5) can generate a transaction timing chart or the like from the information of the execution start timing and output the transaction timing chart or the like.

As above, according to the simulation apparatus of the present embodiment, if the bus architecture information and the bus target information are set, simulation of the designated TL model can be performed even if a user who is a system architecture studying operator does not make correction such as rewrite of the TL model of a bus target.

In the above described example, one transaction converting section 16A is provided for the bus, but the transaction converting module may be provided at each bus target. FIG. 17 is a transaction level model diagram in which a transaction converting module is provided at each bus target. As shown in FIG. 17, transaction converting sections 16Aa and 16Ab are provided to correspond to the bus targets 13 and 14, respectively, and output converted transactions TT3 and TT4 respectively.

Furthermore, in the above described example, when the size of the transaction from the bus is smaller than the expected size, the transactions from the bus are integrated to be the transaction in the expected size to be outputted to the bus target, but the transaction from the bus may be supplied as it is directly to the bus target without being integrated.

More specifically, in integration of transactions, integration of a plurality of transactions is not performed, and only calculation of information of how many transactions are integrated, and when the transaction is outputted is performed, in the integration of transactions. For example, when four transactions are integrated, the transaction converting section (S4) does not perform integration of the transactions from the bus, but calculates and obtains each of virtual output times (time information such as the aforementioned time 100 and the like) of the integrated transaction when the transactions are assumed to be integrated.

This can save the time taken for integration and transfer processes of the transactions in the simulation process, and therefore, provides an advantage of leading to enhancement in speed of simulation. The number of integrations of transactions is calculated, only calculation of a transfer time of integrated transaction by bus arbitration is performed, and a calculation result can be obtained. Therefore, an execution start timing of the processing in the bus target can be determined Accordingly, a simulation result can be obtained similarly to the above description.

For example, when the bus initiator issues a transaction of 16 bytes, the transaction is divided into four data of “0×AABB”, “0×CCDD”, “0×EEFF” and “0×GGHH” to be transferred through the bus, and the bus target executes a process if the bus target has all the data corresponding to 16 bytes, the four transactions are integrated into one. At this time, the calculation process of the number of integrations of the transactions, and the integration process of the integrated transaction data “0×AABBCCDDEEFFGGHH” are usually performed, but in this case, only the calculation process of the number of integrations of transactions is performed, whereas the integration process of the transactions is not performed, and transfer of the four data of “0×AABB”, “0×CCDD”, “0×EEFF” and “0×GGHH” to the bus target is performed. Since transfer of the four data of “0×AABB”, “0×CCDD”, “0×EEFF” and “0×GGHH” to the bus target is performed, there is no problem in the processing in the bus target.

As above, when the size of the transaction from the bus is smaller than the expected size, the transaction converting module creates virtual output time information in a case of assuming that the transactions from the bus are integrated to one so that transactions from the bus become transactions in the expected size, outputs the transactions from the bus as they are directly to the bus target, and does not execute integration processing of the transactions.

More specifically, the simulation executing section (S4) obtains the virtual output time of the integrated transaction in the case of assuming that the transactions are integrated by calculation, and determines the execution start timing of the processing in the bus target included in the semiconductor integrated circuit based on the virtual output time information of the converted transaction which is obtained in simulation.

As above, even when exchange of the transaction and calculation of timing time are separately performed, simulation can be executed without rewrite of the TL model of the bus target.

### THIRD EMBODIMENT

The first embodiment is the simulation apparatus which performs simulation by setting the transaction converting module between the bus and the bus initiator in the TL model, and the second embodiment is the simulation apparatus which performs simulation by setting the transaction converting module between the bus and the bus target in the TL model, whereas the third embodiment relates to a simulation apparatus which performs simulation by setting the transaction converting sections 16 and 16A between a bus and a bus initiator, and between the bus and a bus target respectively in the TL model.

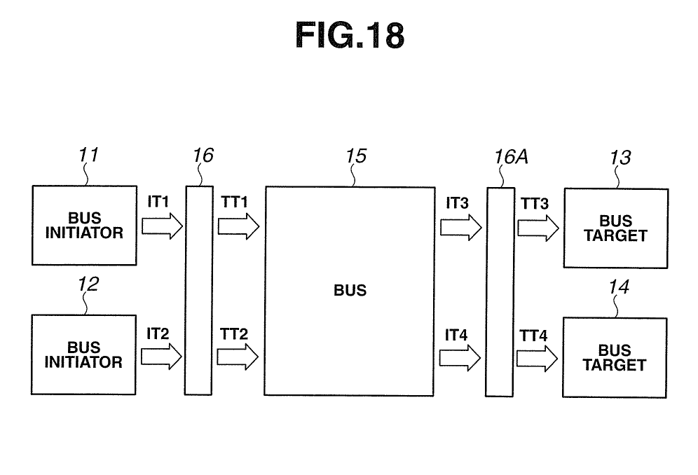

FIG. 18 is a transaction level model diagram of a system architecture of a system LSI of the present embodiment.

In the TL models, the transaction converting section 16 of the first embodiment is provided between the bus initiators 11 and 12, and the bus 15, and the transaction converting section 16A of the second embodiment is set between the bus 15, and the bus targets 13 and 14, and simulation is performed.

The components and the processing contents of the transaction converting sections 16 and 16A are respectively similar to the transaction converting sections 16 and 16A of the aforementioned first and second embodiments.

Accordingly, even if change in the bus architecture is made when the system architecture of the LSI is studied, a change operation such as rewrite of the TL models of the bus initiators and the bus targets and the like are not needed.

In the above described example, one transaction converting section 16 and one transaction converting section 16A are provided for the bus, but as shown in FIGS. 10 and 17, the transaction converting modules may be provided for each of the bus initiators and each of the bus targets.

As above, according to the simulation apparatus of each of the aforementioned embodiments, change or rewrite of the TL model can be made unnecessary when a change in the bus architecture is made.

A program which executes the operation described above is entirely or partially recorded or stored in a flexible disk, a movable medium such as a CD-ROM, a recording medium such as a hard disk, as computer program products. The program is read by a computer and all or part of the operation is executed. Alternatively, all or part of the program can be distributed or provided via communication networks. A user can easily realize the simulation apparatuses and the methods thereof of the present embodiments by downloading the program via a communication network and installing the program in a computer, or installing the program in a computer from a recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor integrated circuit simulation apparatus, comprising:
a bus-architecture-information-acquisition module configured to acquire bus architecture information regarding a bus in a semiconductor integrated circuit;
a transfer-size-calculator configured to calculate a transfer size conforming to the bus architecture, based, at least in part, on the acquired bus architecture information; and
a simulation module configured to simulate the semiconductor integrated circuit by setting a transaction-converter configured to
convert a first transaction from a bus initiator included in the semiconductor integrated circuit into a second transaction in a size conforming to the transfer size and
output the second transaction to the bus.

2. The semiconductor integrated circuit simulation apparatus of claim 1, wherein
when a size of the first transaction from the bus initiator is larger than the transfer size, the transaction converter is configured to
divide the first transaction from the bus initiator into a plurality of transactions, each having a size conforming to the transfer size,
output the plurality of transactions to the bus, and
when the size of the transaction from the bus initiator is smaller than the transfer size, the transaction converter is configured to
combine first transactions from the bus initiator, thereby creating an integrated transaction having a size conforming to the transfer size, and
output the integrated transaction to the bus.

3. The semiconductor integrated circuit simulation apparatus of claim 1,
wherein the simulation module is configured to determine an execution start timing of a process in a bus target included in the semiconductor integrated circuit, based on output time information of a converted transaction which is obtained in the simulation.

4. The semiconductor integrated circuit simulation apparatus of claim 1,
wherein when a size of the first transaction from the bus initiator is larger than the transfer size, the transaction converter is configured to
assume that the first transaction from the bus initiator is divided into a plurality of transactions each having a size conforming to the transfer size and that the plurality of transactions is outputted to the bus, and
based on the assumption, generate virtual output time information.

5. The semiconductor integrated circuit simulation apparatus of claim 4,
wherein the simulation module determines an execution start timing of a process in a bus target included in the semiconductor integrated circuit, based on the virtual output time information generated by the transaction converter.

6. The semiconductor integrated circuit simulation apparatus of claim 1, further comprising:
a simulation-result output configured to output a result of the simulation by the simulation module.

7. The semiconductor integrated circuit simulation apparatus of claim 1, further comprising:
a bus-target-information acquisition module configured to acquire bus target information comprising a start condition with which a bus target included in the semiconductor integrated circuit will accept a transaction and start an operation; and
a bus-target-transfer-size calculator configured to calculate a transfer size for the bus target conforming to the bus target, based on the acquired bus target information,
wherein the simulation module is configured to set a transaction converter for the bus target, the transaction converter being configured to convert the first transaction into the second transaction and output the second transaction to the bus target.

8. The semiconductor integrated circuit simulation apparatus of claim 1,
wherein the bus and the bus initiator are transaction models.

9. A semiconductor integrated circuit simulation apparatus, comprising:
a bus-target-information acquisition module configured to acquire bus target information including a start condition with which a bus target included in a semiconductor integrated circuit will accept a transaction and start operation;
a transfer-size calculator configured to calculate a transfer size conforming to the bus target, based on the acquired bus target information; and
a simulation module configured to simulate the semiconductor integrated circuit by setting a transaction converter configured to convert a first transaction from a bus included in the semiconductor integrated circuit into a second transaction having a size conforming to the transfer size and output the transaction to the bus target.

10. The semiconductor integrated circuit simulation apparatus of claim 9, wherein
when a size of the first transaction from the bus is larger than the transfer size, the transaction converter is configured to
divide the first transaction from the bus into a plurality of transactions each having a size conforming to the transfer size, and
output the plurality of transactions to the bus target, and
when the size of the first transaction from the bus is smaller than the transfer size, the transaction converter is configured to
combine first transactions from the bus, thereby forming an integrated transaction having a size conforming to the transfer size, and
output the integrated transaction to the bus target.

11. The semiconductor integrated circuit simulation apparatus of claim 9,
wherein the simulation module is configured to determine an execution start timing of a process in the bus target, based on output time information of the converted transaction which is obtained in the simulation.

12. The semiconductor integrated circuit simulation apparatus of claim 9,
wherein when a size of the first transaction from the bus is smaller than the transfer size, the transaction converter is configured to
assume that transactions from the bus are combined into an integrated transaction having a size conforming to the transfer size, and
based on the assumption, generate virtual output time information.

13. The semiconductor integrated circuit simulation apparatus of claim 12,
wherein the simulation executing module determines an execution start timing of a process in the bus target, based on the virtual output time information generated by the transaction converter.

14. A simulation method for a semiconductor integrated circuit comprising:
with a bus-architecture-information acquisition module, acquiring bus architecture information of a bus included in a semiconductor integrated circuit;
with a transfer-size calculator, calculating a transfer size conforming to the bus architecture, based on the acquired bus architecture information; and
with a simulation module, simulating the semiconductor integrated circuit by setting a transaction converter configured to convert a first transaction from a bus initiator included in the semiconductor integrated circuit into a second transaction having a size conforming to the transfer size and configured to output the second transaction to the bus.

15. The simulation method of claim 14, wherein
when a size of the first transaction from the bus initiator is larger than the transfer size, the transaction converter module further
divides the first transaction from the bus initiator into a plurality of transactions each confirming to the transfer size, and
outputs the plurality of transactions to the bus, and
when the size of the first transaction from the bus initiator is smaller than the transfer size, the transaction converter further
combines first transactions from the bus initiator, thereby forming an integrated transaction having a size conforming to the transfer size, and
outputs the integrated transaction to the bus.

16. The simulation method of claim 14,
wherein the simulation executing module further determines an execution start timing of a process in a bus target included in the semiconductor integrated circuit, based on output time information of the converted transaction obtained in the simulation.

17. The simulation method of claim 14,
wherein when a size of the first transaction from the bus initiator is larger than the transfer size, the transaction converter further
assumes that the first transaction from the bus initiator is divided into
a plurality of transactions, each having a size conforming to the transfer size,
and that the plurality of transactions is outputted to the bus, and
based on the assumption generates virtual output time information.

18. The simulation method of claim 17,
wherein the simulation executing module further determines an execution start timing of a process in a bus target included in the semiconductor integrated circuit, based on the virtual output time information generated by the transaction converting module.

19. The simulation method of claim 14,
wherein a simulation result output outputs a result of the simulation by the simulation module.

20. The simulation method of claim 14, further comprising
with a bus-target information acquisition module, acquiring bus target information including a start condition with which a bus target included in the semiconductor integrated circuit will accept a transaction and start an operation; and
with a transfer-size calculator, calculating a transfer size for the bus target conforming to the bus architecture, based on the acquired bus target information, and
wherein the simulation module sets a transaction converter for the bus target, the transaction converter being configured to convert a transaction from the bus into a transaction in a size conforming to the transfer size for the bus target and to output the transaction to the bus target, and performs simulation of the semiconductor integrated circuit.
